(19) United States
(12) Patent Application Publication
(10) Pub. No.: US 2009/0276574 A1
(43) Pub. Date: Nov. 5, 2009

(54) ARITHMETIC DEVICE, ARITHMETIC METHOD, HARD DISC CONTROLLER, HARD DISC DEVICE, PROGRAM CONVERTER, AND COMPILER

(75) Inventors: Yoriharu TAKAI, Kodaira-shi (JP); Kenji YOSHIDA, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/370,056

(22) Filed: Feb. 12, 2009

(30) Foreign Application Priority Data
Apr. 30, 2008 (JP) 2008-118795

(51) Int. Cl. G06F 12/08; G06F 9/44

(52) U.S. Cl. 711/118; 717/110; 360/69; 711/E12.017

(57) ABSTRACT

This arithmetic device includes: a first memory to store a first program; a first arithmetic module to read the first program from the first memory to execute the first program; a second memory to store a second program which is embedded in processing of the first program and called from the first arithmetic module and executed, and whose access speed is lower than the first memory; a third memory storing data temporarily and whose access speed is higher than the second memory; a second arithmetic module to read the second program from the second memory and store in a third memory; and a third arithmetic module to read the second program from the third memory to execute the second program, in accordance with a call from the first arithmetic module to execute the first program.

### CROSS-REFERENCE TO RELATED APPLICATION

This application is based upon and claims the benefit of priority from the prior Japanese Patent Application No. 2008-118795, filed on Apr. 30, 2008; the entire contents of which are incorporated herein by reference.

### BACKGROUND OF THE INVENTION

1. Field of the Invention

The present invention relates to a memory access control of a processor, for example, to an arithmetic device to perform the memory access control of the processor provided in a disc device, an arithmetic method, a hard disc controller, a hard disc device, a program converter, and a compiler.

2. Description of the Related Art

It is preferable that a memory that a processor, being an arithmetic device, uses is high-speed, high-capacity, and low-priced. In particular, in an embedded processor used in a hard disc controller (HDC) controlling a disc device such as a magnetic recording device, considering demanded performance, a cost, and the like, a memory which is high-speed and small-capacity, and a memory which is low-speed and high-capacity are provided and used selectively (for example, JP-A 2005-301792 (KOKAI)).

In an embedded system such as the HDC, a program code is determined uniquely. Thus, a high-speed memory and a low-speed memory are connected in series on a memory map, and a program that speed is necessary is placed in the high-speed memory, and a program that speed is not so necessary is placed in the low-speed memory, thereby, processing efficiency is realized in the system.

However, in a conventional processor, in the case when a program placed in a low-speed memory is read and executed, it takes more time than the case when a program placed in a high-speed memory is read and executed, therefore, in the case when the respective programs are mixed together, processing efficiency is deteriorated. In the meantime, in general, the high-speed memory is more expensive than the low-speed memory, and capacity thereof is limited, therefore, it is also limited that all programs are placed in the high-speed memory.

### BRIEF SUMMARY OF THE INVENTION

As described above, there are problems that processing efficiency is low, and when speed-up is realized, a cost is increased in a conventional arithmetic device, arithmetic method, hard disc controller, hard disc device, program converter, and compiler.

The present invention is made to solve the problems as described above, and an object thereof is to provide an arithmetic device, an arithmetic method, a hard disc controller, a hard disc device, a program converter, and a compiler, whose processing efficiency is high.

To attain the above-described object, an arithmetic device according to an aspect of the present invention includes: a first memory to store a first program; a first arithmetic module to read the first program from the first memory to execute the first program; a second memory to store a second program which is embedded in processing of the first program and called from the first arithmetic module and executed, and whose access speed is lower than the first memory; a third memory to store data temporarily and whose access speed is higher than the second memory; a second arithmetic module to read the second program from the second memory and store in a third memory; and a third arithmetic module to read the second program from the third memory to execute the second program, in accordance with a call from the first arithmetic module to execute the first program.

An arithmetic method according to another aspect of the present invention includes the following steps: storing a first program in a first memory; storing a second program which is embedded in processing of the first program and called based on an execution of the first program in a second memory whose access speed is lower than the first memory; reading the first program from the first memory to execute the first program; before the second program is called from the second memory based on the execution of the first program, reading the second program from the second memory to store in a third memory storing data temporarily, and whose access speed is higher than the second memory; and reading the second program from the third memory to execute the second program, in accordance with a call from the second program based on the execution of the first program.

A program converter according to further another aspect of the present invention includes: an analysis module to analyze a program source including a first instruction code stored in a first memory and a second instruction code stored in a second memory whose speed is lower than the first memory, and called from the first instruction and executed, and extracting position information of the first instruction and the second instruction; a definition table to define a reference to set a position to insert a third instruction code copying the second instruction code from the second memory into a third memory storing data temporarily, and whose speed is higher than the second memory regarding the program source; a search module to search a position to insert the third instruction code in the program source based on the defined reference by the definition table and the position information of the first instruction and the second instruction; and a code insertion module to insert the third instruction code in the position searched in the search module.

### BRIEF DESCRIPTION OF THE DRAWINGS

FIG. 1 is a block diagram showing a structure of a hard disc device of one embodiment of the present invention.

FIG. 2 is a view showing an example of a basic program that a controller of this embodiment executes.

FIG. 3 is a conceptual view to explain a basic operation of the controller of this embodiment.

FIG. 4 is a block diagram showing a functional configuration of the controller of this embodiment.

FIG. 5 is a program list showing an operation of the controller of this embodiment.

FIG. 6 is a flowchart showing the operation of the controller of this embodiment.

FIG. 7 is a conceptual view to explain the operation of the controller of this embodiment.

FIG. 8 is a block diagram showing a functional configuration of a comparison example of the controller of this embodiment.

FIG. 9 is a flowchart showing an operation of the comparison example of the controller of this embodiment.

FIG. 10 is a block diagram showing a configuration of a compiler device according to this embodiment.

FIG. 11 is a flowchart showing an operation of the compiler device of this embodiment.

FIG. 12 is a view showing one example of a program that a CPU core executes in this embodiment.

FIG. 13 is a view showing one example of the program that the CPU core executes in this embodiment.

### DETAILED DESCRIPTION OF THE INVENTION

In an embodiment of the present invention, a high-speed memory and a lower-speed memory than the high-speed memory are provided, and a processor of which a program that high-speed processing is required is placed (stored) in the high-speed memory and a program that high-speed processing is not required is placed in the low-speed memory is used, and while executing the program placed in the high-speed memory, the program placed in the low-speed memory which is supposed to be executed later is read to a high-speed cache area beforehand, thereby, processing efficiency of the program placed in the low-speed memory is improved. That is, the program placed in the low-speed memory which takes time to read is read to a cache memory beforehand, thereby, speed-up of processing as a whole is realized.

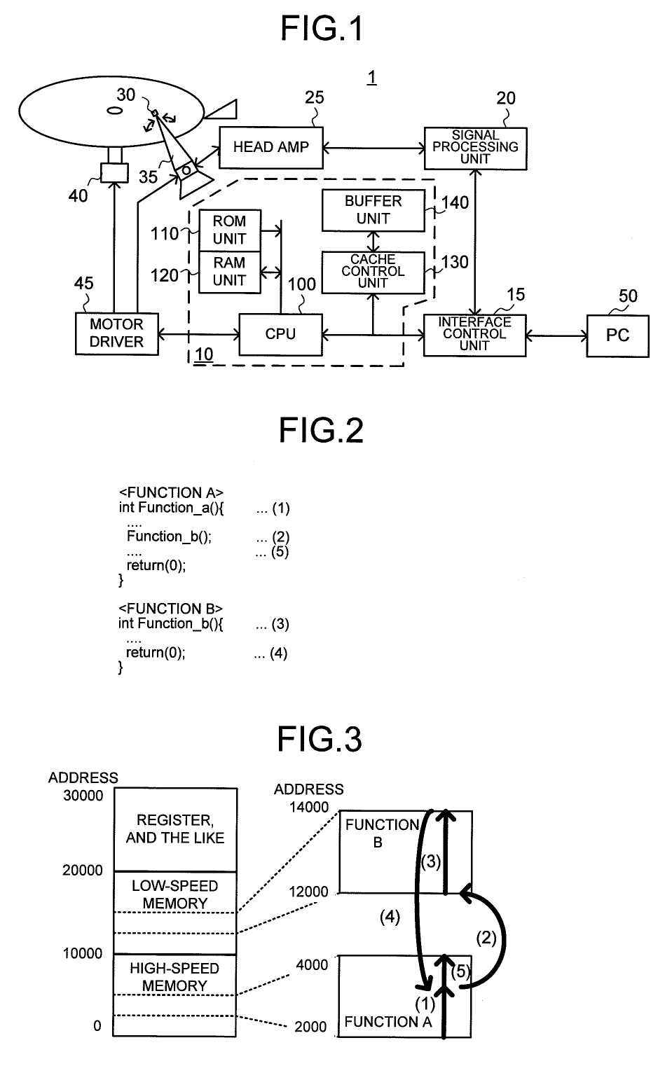

Hereinafter, an embodiment of the present invention is explained in detail with reference to drawings. FIG. 1 is a block diagram showing a structure of a hard disc device (HDD) 1 of the embodiment according to the present invention. As shown in FIG. 1, the HDD 1 of this embodiment includes a controller 10, an interface control unit 15, a signal processing unit 20, a head amp 25, a head 30, an actuator 35, a spindle motor 40, and a motor driver 45.

The controller 10 controls the entire recording/reproducing operation of the HDD 1. The controller 10 includes an arithmetic unit (CPU) 100, an ROM unit 110, an RAM unit 120, a cache control unit 130, a buffer unit 140, and so on. The CPU 100 is an RISC-CPU suitable for the use of, for example, an embedded system. The ROM unit 110 is a nonvolatile memory in which a command that the CPU 100 executes, a program to define an operation of the controller 10, and so on are stored, which is for example a flash memory. The RAM unit 120 is a static memory configured to be accessible directly to the CPU 100 without going through external/internal buses, which is for example, a tight coupled memory (Tight Coupled Memory: TCM). The RAM unit 120 has functions to store all or a part of a program and data stored in the ROM unit 110 and provide directly to the CPU 100.

The cache control unit 130 is a memory mechanism to hold temporarily a command, a program, data, and so on that the CPU 100 reads from the ROM unit 110 and the RAM unit 120. The data and the like stored in the cache control unit 130 is updated/discarded in accordance with capacity, time, and the like when necessary. The buffer unit 140 is a memory to store a program and data stored in the ROM unit 110 and provide to the CPU 100, which is, for example, a DRAM. The buffer unit 140 is larger in capacity and capable of storing more data compared with the RAM unit 120, however, its access speed is lower than the RAM unit 120. Therefore, the buffer unit 140 is unsuitable for storing a program that requires a high processing speed. On the other hand, the RAM unit 120 is suitable for storing a program that high-speed processing is required, and the like since its access speed is high. It is configured such that a series of addresses are assigned to the RAM unit 120 and the buffer unit 140 together with a not-shown register, and the CPU 100 is accessible integrally. In the following explanation, the RAM unit 120 may be called as “a high-speed memory”, and the buffer unit 140 may be called as “a low-speed memory”.

The interface control unit 15 is an interface in order to connect a computer (PC) 50 to be a host of the HDD 1. The interface control unit 15 can exchange data with the PC 50 using, for example, a SATA interface, a SCSI interface, and the like. The signal processing unit 20 performs processing to convert data sent via the interface control circuit 15 into a format suitable for magnetic recording, and performs processing to convert the data read in a magnetic recording format into a format suitable for transmitting via the interface control unit 15. The head amp 25 amplifies a recording signal converted in the signal processing unit 20 to a predetermined level and sends it to the head (a recording/reproducing head), and further amplifies the signal read in the head to a predetermined level and sends it to the signal processing unit 20. The head 30 is an element to record and read a signal on a magnetic recording disc. The head 30 is disposed on a not-shown slice disposed on an end of the actuator. The actuator 35 is a drive mechanism to shift the head 30 disposed on the end portion in a surface direction on the magnetic recording disc. The actuator 35 includes a not-shown motor inside thereof, and operates so as to rotate within a predetermined angle in the surface direction of the magnetic recording disc by an external control. The spindle motor 40 rotates the magnetic recording disc in the surface direction. The motor driver 45 controls the motor in the actuator 35 and the spindle motor 40 independently based on an instruction from the CPU 100.

Here, a basic operation of the controller 10 in the HDD 1 of this embodiment is explained with reference to FIG. 2 and FIG. 3. FIG. 2 is a view showing an example of a basic program that the controller 10 of this embodiment executes, and FIG. 3 is a conceptual view to explain the basic operation of the controller 10 of this embodiment. To simplify the explanation, as one example, the controller 10 of this embodiment is to execute a function A (Function_a) which is stored in the RAM unit 120 as the high-speed memory to operate, and a function B (Function_b) which is stored in the buffer unit 140 as the low-speed memory to operate. Further, the function B is called from the function A and executed as a subroutine. The function A and the function B are stored in the ROM unit 110 beforehand.

The CPU 100 assigns a series of addresses to the RAM unit 120 as the high-speed memory, the buffer unit 140 as the low-speed memory, the register, and the like and manages in a unified manner. In the example shown in FIG. 3, address 0 to address 10000 are assigned in the RAM unit 120 as the high-speed memory, address 10000 to address 20000 are assigned in the buffer unit 140 as the low-speed memory, and address 20000 to address 30000 are assigned in the register and the like, and a unified access is possible. That is, on an address map seen from the CPU 100, in terms of the hardware, the high-speed memory, the low-speed memory, the register, and so on are assigned integrally. A program code necessary for the operation of the CPU 100 is placed in an accessible area on a memory map, and when the program is placed in the high-speed memory, processing is executed at a high-speed, and when the program is placed in the low-speed memory, processing is executed at a low-speed.

After accepting an instruction to drive the HDD 1 via the interface control unit 15 from the PC 50, the CPU 100 reads the function A and the function B stored in the ROM unit 110 and copies the function A and the function B into the RAM unit 120 and the buffer unit 140. At this time, the CPU 100 stores the function A which the high-speed processing is required at predetermined addresses (for example, address 2000 to address 4000) of the RAM unit 120 as the high-speed memory, and the function B which the high-speed processing is not required at predetermined addresses (for example, address 12000 to address 14000) of the buffer unit 140 as the low-speed memory.

And then, the CPU 100 reads a program from a head address of Function_a (for example, address 2000) to execute the program ((1) in FIGS. 2 and 3, the same is applicable hereinafter), and next, calls Function_b in the process of the processing of Function_a (2). The processing of the CPU 100 jumps to a head address of Function_b (for example, address 12000). The CPU 100 executes the processing of Function_b (3), after executing the processing until the last address of Function_b (for example, address 14000), the CPU 100 executes the subsequent processing of Function_a (4). After the processing of Function_a continues to the end (5), the CPU 100 ends the processing.

The function A and the function B are stored in the RAM unit 120 and the buffer unit 140 whose processing speeds are different respectively. Thus, as this example, in the case when the function B which the high-speed processing is unnecessary is called from the function A which the high-speed processing is necessary, reading the function B from the buffer unit 140 results in a bottleneck. The controller 10 of this embodiment performs the access of the CPU 100 to the function B not in the buffer unit 140 but in the cache control unit 130, which makes the high-speed processing possible.

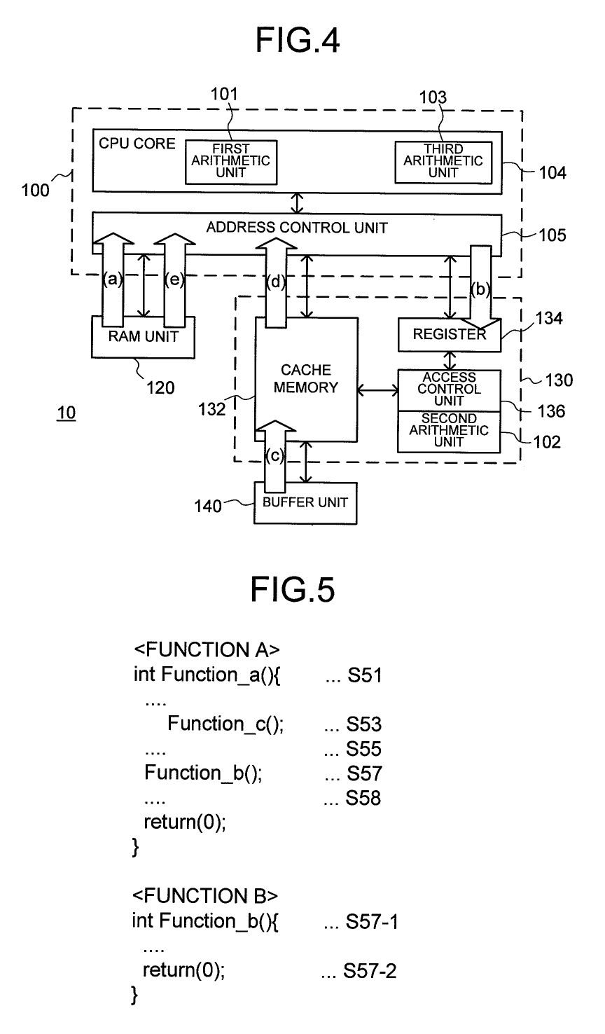

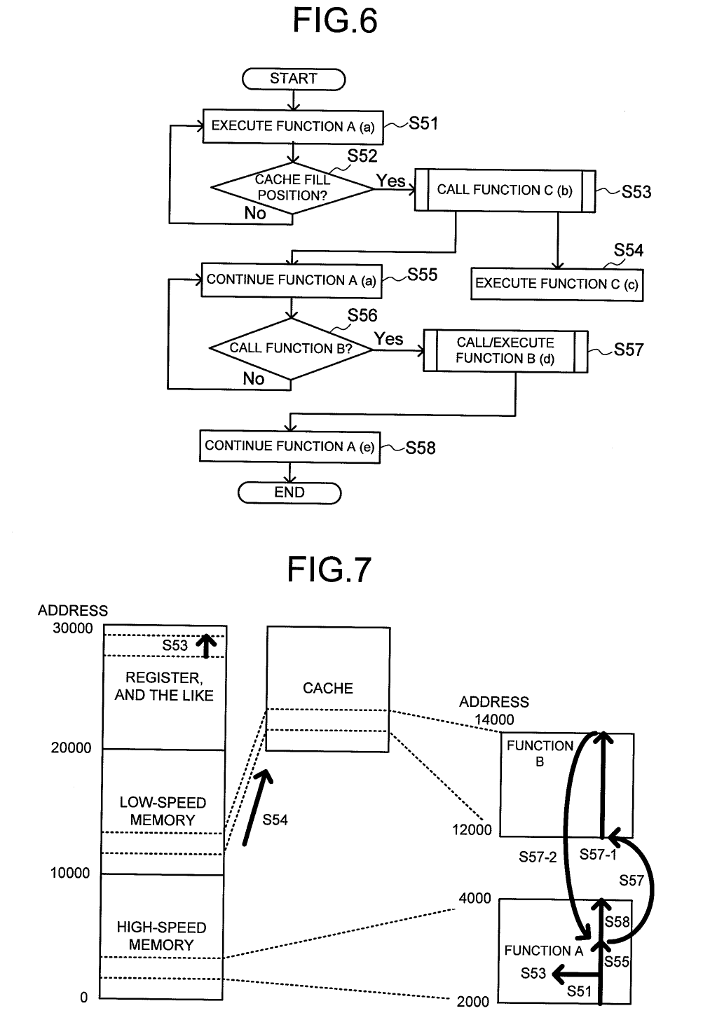

And next, the controller 10 of this embodiment is explained in detail with reference to FIG. 4 to FIG. 7. FIG. 4 is a block diagram showing a functional configuration of the controller 10 of this embodiment, FIG. 5 is a view of a program list showing the operation of the controller 10 of this embodiment, FIG. 6 is a flowchart showing the operation of the controller 10 of this embodiment, and FIG. 7 is a conceptual view to explain the operation of the controller 10 of the embodiment.

As shown in FIG. 4, the CPU 100 in the controller 10 of this embodiment includes a CPU core 104 to execute an arithmetic operation, and an address control unit 105 to function as an address decoder and a selector of the memory that the CPU 100 accesses. The CPU core 104 executes programs stored in the RAM unit 120 and the buffer unit 140, however, to simplify the explanation, herein, it is explained that a first arithmetic unit 101 as a functional element to execute the function A, and a third arithmetic unit 103 as a functional element to execute the function B are included in the CPU core 104. The address control unit 105 assigns a series of address to the RAM unit 120, the buffer unit 140, the register, and so on to realize a unified access.

Further, the cache control unit 130 in the controller 10 of this embodiment includes a cache memory 132 to store data read from the buffer unit 140 temporarily, a register 134 to store a command that the CPU core 104 executes, and the like temporarily, and an access control unit 136 to control an access to the register. The register 134 is a memory mechanism to store a procedure of the processing to read from the low-speed memory to the cache that a second arithmetic unit 102 executes. The register 134 includes the second arithmetic unit 102 as a functional element to execute the processing to read the program stored in the low-speed memory, and the like to the cache. The register 134 is different from a register included in a so-called processor, and realized by the hardware together with the access control unit 136 and the like. It is configured such that before reading data from the ROM unit 110/the RAM unit 120 and the buffer unit 140, the first and the third arithmetic units 101 and 103 of the CPU core 104 refer to the cache memory 132, and then read the data in the cache memory 132 when the data to read exists in the cache memory 132.

The program list shown in FIG. 5 is stored in the ROM unit 110 of this embodiment, and the CPU core 104 stores the program in the RAM unit 120 and the buffer unit 140 respectively before an execution. That is, the function A is stored in the RAM unit 120, and the function B is stored in the buffer unit 140. The first arithmetic unit 101 has a function to execute the function A, the third arithmetic unit 103 has a function to execute the function B, and the second arithmetic unit 102 has a function to store a copy of the function B stored in the buffer unit 140 into the cache memory 132 as a function C. As shown in FIG. 5, the processing to call the function B and execute the function B is included in the processing of the function A (Function_b), and further, the processing to call the function C and execute the function C at an earlier stage than a step to call the function B is included therein (Function_c).

Subsequently, the operation of the controller 10 of this embodiment is explained with reference to FIG. 4 to FIG. 7. After the function A and the function B are copied from the ROM unit 110 into the RAM unit 120 and the buffer unit 140 respectively ((a) shown in FIG. 4, the same is applicable hereinafter), the first arithmetic unit 101 executes the function A (Step 51, hereinafter, called as “S51”).

Until Function_c to call the function C appears in the processing of the function A to be executed (No at S52), the first arithmetic unit 101 continues to execute the processing of the function A. In the case when Function_c to call the function C appears (Yes at S52), the first arithmetic unit 101 accesses the register 134 (b), and calls the function C (S53). After the function C is called, the second arithmetic unit 102 in the access control unit 136 executes the function C (S54), and copies the program of the function B stored in the buffer unit 140 into the cache memory 132 (c). After the function C is called and copy processing is started, the first arithmetic unit 101 continues to execute the subsequent processing of the function A (S55). The function of the function C to copy the program of the function B from the buffer unit 140 into the cache memory 132 is realized by the register whose access speed is high and hardware resources executed directly by the register. Accordingly, the copy processing from the buffer unit 140 into the cache memory 132 (the processing of the function C) is executed at a high-speed in parallel to the processing of the function A. The first arithmetic unit 101 executes the subsequent processing of the function A until the position to call the function B (No at S56).

And then, when Function_b to call the function B appears in the processing of the function A to be executed (Yes at S56), the first arithmetic unit 101 calls the function B. It is configured such that before accessing the memory, the CPU core 104 verifies whether the function B is stored in the cache memory 132, when stored, the content in the cache memory 132 is read, thereby, at this time, the first arithmetic unit 101 first verifies whether the function B is stored in the cache memory 132. The program of the function B copied at Step 53 is stored in the cache memory 132, thereby, the first arithmetic unit 101 calls the program of the function B stored not in the buffer unit 140 but in the cache memory 132. When the program of the function B is called, the third arithmetic unit 103 reads the function B from the cache memory 132 (d), and executes the read function B (S57). As shown in FIG. 7, the third arithmetic unit 103 executes the program of the function B stored in the cache memory 132 (S57-1, S57-2). When the processing of the function B is ended, the first arithmetic unit 101 continues the subsequent processing of the function A (S58). After all of the processing of the function A is ended, the first arithmetic unit 101 stops the operation.

According to the controller 10 of this embodiment, before the program of the function B whose access speed is low is read from the function A being a parent program, the function B is copied from the buffer unit 140 being the low-speed memory into the cache memory 132 whose speed is relatively high beforehand. And then, the function B copied into the cache memory 132 is referred and executed. Therefore, speed-up of the processing can be realized compared with the case that the function B is read directly from the low-speed memory and executed.

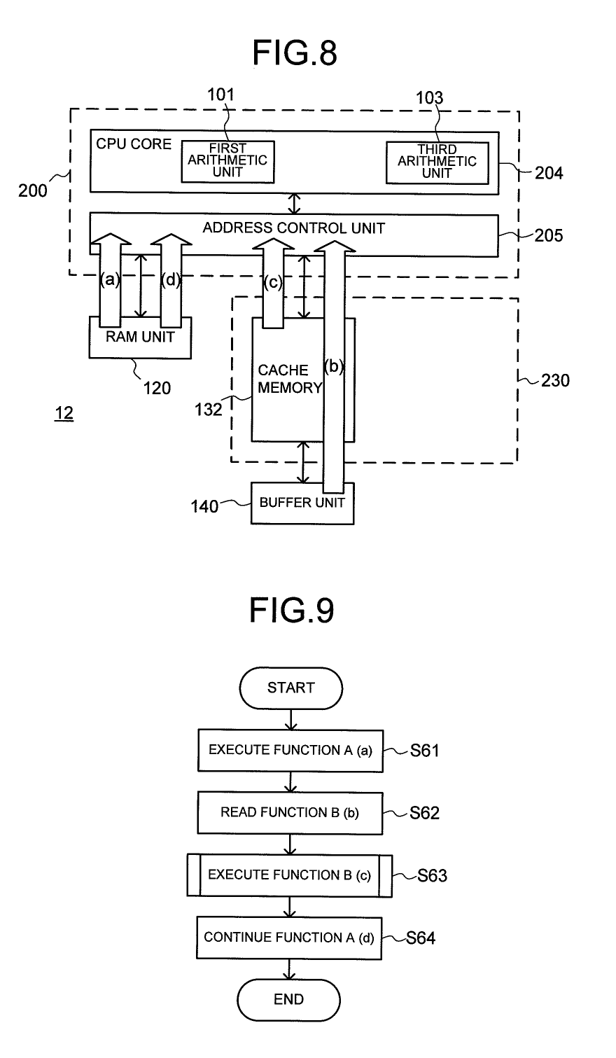

Here, a case that the copy processing from the low-speed memory into the cache memory (the processing of the function C) is not executed is explained with reference to FIG. 8 and FIG. 9 as a comparison example of the controller 10 of this embodiment. FIG. 8 is a block diagram showing a functional configuration of the comparison example of the controller 10 of this embodiment, and FIG. 9 is a flowchart showing an operation of the comparison example of the controller 10 of this embodiment. The comparison example does not include the configuration regarding the cache memory of the embodiment shown in FIG. 4, therefore, the same numbers and symbols are given to components common to FIG. 4, and overlapping explanation is omitted.

In the comparison example as shown in FIG. 8, a CPU 200 includes a CPU core 204 and an address control unit 205. Further, similarly compared with the address control unit 105 in the embodiment of the present invention, an access to the register to execute the function C is omitted in the address control unit 205. Further, a cache control unit 230 does not include the second arithmetic unit 102 to execute the function C, the register 134, the access control unit 136, and so on compared with the cache control unit 130 in the embodiment of the present invention.

Here, the operation of this comparison example is explained. When the function A and the function B are copied respectively from an ROM unit 110 into an RAM unit 120 and a buffer unit 140 ((a) shown in FIG. 8, the same is applicable hereinafter), a first arithmetic unit 101 executes the function A (S61).

When Function_b to call the function B appears in the processing of the function A to be executed, the first arithmetic unit 101 calls the function B. The first arithmetic unit 101 first verifies whether the function B is stored in a cache memory 132. If the function B is executed before the processing of the function A, the cache memory 132 stores the program of the function B (c). However, the function B is stored in the buffer unit 140 normally, therefore, when the first arithmetic unit 101 calls the function B, it results in a so-called read cache miss, and a second arithmetic unit 102 reads the program of the function B stored in the buffer unit 140 (b)/(S62), and then executes the program of the function B (S63). That is, when a third arithmetic unit 103 reads the program of the function B, the third arithmetic unit 103 can read from the cache memory at a high-speed in case of a read cache hit, however, in case of the read cache miss, the third arithmetic unit 103 reads from a low-speed memory, which makes the third arithmetic unit 103 wait for the processing of the function B for read latency.

After the processing of the function B is ended, the first arithmetic unit 101 continues the subsequent processing of the function A (d)/(S64).

As described above, compared with the comparison example shown in FIG. 8, the controller 10 according to the embodiment of the present invention shown in FIG. 4 performs reading of the program of the function B stored in the low-speed memory before the execution of the function B, thereby, in case of the processing of the function B, delay can be suppressed. In particular, in the controller 10 according to the embodiment of the present invention, the copy processing from the buffer unit 140 into the cache memory 132 is executable in parallel to the function A by the register and the hardware structure, therefore, the high-speed processing can be realized.

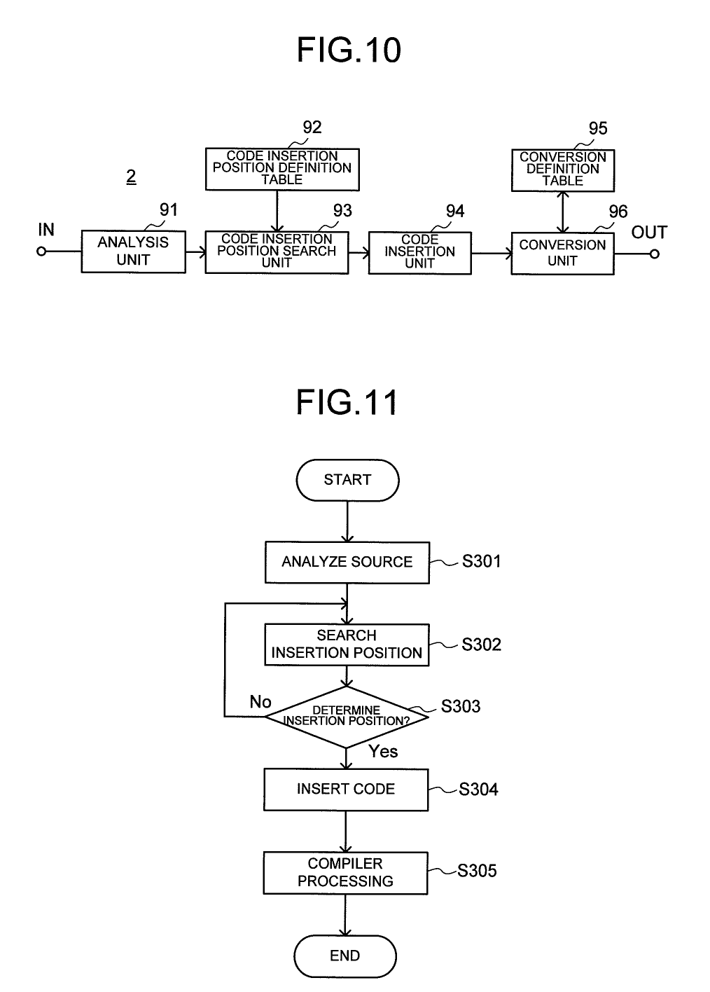

And next, a compiler device according to another embodiment of the present invention is explained with reference to FIG. 10 and FIG. 11. FIG. 10 is a block diagram showing a configuration of a compiler device 2 according to this embodiment, and FIG. 11 is a flowchart showing an operation of the compiler device 2 according to this embodiment. The compiler device in this embodiment sets the program including the functions A and C used in the HDD 1 and the controller 10 shown in FIG. 1 and FIG. 4, namely the program of the function C having the function to copy the program of the function B operating in the low-speed memory into the cache memory before the execution.

As shown in FIG. 10, the compiler device 2 of this embodiment includes an analysis unit 91, a code insertion position definition table 92, a code insertion position search unit 93, a code insertion unit 94, a conversion definition table 95, and a conversion unit 96.

The analysis unit 91 analyzes a program source input from an input IN, and extracts information of the function in the program. Concretely, the analysis unit 91 performs compilation and link processing to an input program code, and extracts addresses at which the respective functions are placed. Analysis information extracted may include sizes of the respective functions, the number of steps, time necessary for the processing, and soon in addition to the addresses of the respective functions. The analysis unit 91 sends the analysis information analyzed together with the input program source to the code insertion position search unit 93.

The code insertion position definition table 92 is a table to define where in the input program source the function C in the embodiment shown in FIG. 4 to FIG. 7, namely, the processing program to copy the program operating in the low-speed memory from the low-speed memory into the cache memory is inserted. For example, considering the case when copying the function B from the low-speed memory into the cache memory, if the function B is copied immediately before the execution of the function B, there is substantially no difference in reading directly from the buffer. Further, as will be described later, there may be a case that it has no sense executing the copy processing depending on timing of the processing. The code insertion position definition table 92 defines a rule in the copy processing considering the above circumstances.

The code insertion position search unit 93 performs processing to search a position for executing the copy processing (a position to call the function C) based on the program source and the analysis information received from the analysis unit 91, and definition information read from the code insertion position definition table 92. The code insertion position search unit 93 applies the definition information defined by the code insertion position definition table 92 to the analysis information and the program source received, and determines the position to execute the copy processing. Concretely, the code insertion position search unit 93 first searches a position where the function placed in the low-speed memory is called among the functions placed in the high-speed memory of the program source. And then, the code insertion position search unit 93 determines a position where backtrace is executed for a predetermined amount from the position where the function placed in the low-speed memory is called. The determined position is where a code for a cache fill, namely, a code for calling a command to copy data from the low-speed memory into the cache memory has to be inserted.

The code insertion unit 94 inserts the code for calling the copy processing in the position to insert the code in the program source determined in the code insertion position search unit 93.

The conversion definition table 95 is a table to define information to convert this program source into an executable format and/or an intermediate format, and the conversion unit 96 is a compiler engine to convert the program source in which the code to call the copy processing is inserted into the executable format, the intermediate format, and the like based on the information defined by the conversion definition table 95. That is, the compiler device in this embodiment is a combination of a text filter in which the analysis unit 91, the code insertion position definition table 92, the code insertion position search unit 93, and the code insertion unit 94 are provided and a compiler to execute actual compilation processing.

Subsequently, the operation of the compiler device 2 of the embodiment shown in FIG. 10 is explained with reference to FIG. 11. After the program source is input from the input IN, the analysis unit 91 extracts the analysis information of the function and the address, and the like included in the program source, and sends the analysis information together with the program source to the code insertion position search unit 93 (S301).

The code insertion position search unit 93 refers to the code insertion position definition table 92, and applies the rule defined by the table to the program source, and searches a position to call the copy processing (a position to insert a code to perform the call) (S302). When the insertion position is not determined (No at S303), the code insertion position search unit 93 continues to search (S302).

When the insertion position is determined (Yes at S303), the code insertion position search unit 93 sends information of the determined insertion position and the program source to the code insertion unit 94. Then, the code insertion unit 94 inserts a predetermined call code in the insertion position of the received program source based on the information of the received insertion position (S304). The program source in which the code is inserted is sent to the conversion unit 96.

After receiving the program source in which the predetermined code is inserted, the conversion unit 96 refers to the conversion definition table 95, and performs conversion processing for the program source, and outputs it to an output OUT.

Here, the amount of backtrace is explained among the information defined by the code insertion position definition table 92. As described above, in the compiler device of this embodiment, the code to copy the program from the low-speed memory into the cache memory is inserted in the program. It is necessary that the insertion position should be the position traced back before the position to call the function operating in the low-speed memory. This amount to trace back is the amount of backtrace. When the amount of backtrace is taken too large, there is a possibility that the program of the function read in the cache memory disappears, otherwise, when it is taken too small, the execution of the function in the low-speed memory results in starting before copying from the low-speed memory into the cache memory is completed.

This amount of backtrace can set the number of processing steps of the CPU core 104 (the number of processing clocks of the CPU core 104), the number of lines in the program source, the number of lines of a code after compilation and assembly, and the like as a reference, and calculate an appropriate amount in consideration of time necessary to copy from the low-speed memory into the cache memory. However, in the case when there are a branch instruction and a jump instruction between the previously described code insertion position and the actual position to call the function, care is needed. This is because copying the program from the low-speed memory into the cache memory is performed even in a situation where the function is not called actually.

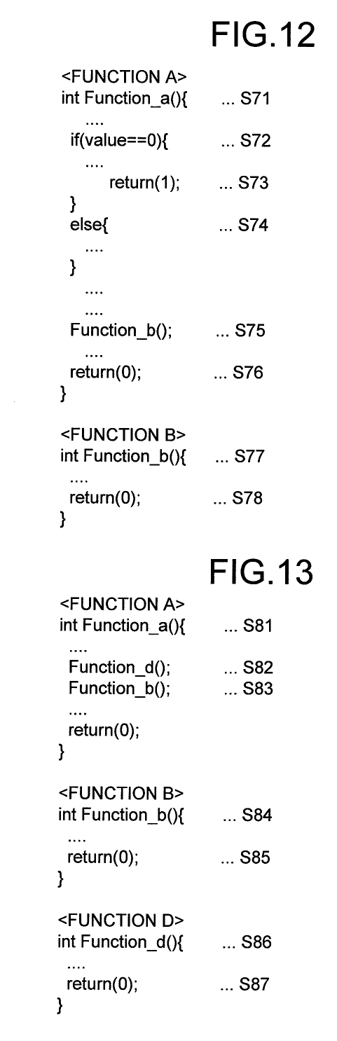

An example of a condition (rule) when calculating the amount of backtrace is explained with reference to FIGS. 12 and 13. FIG. 12 and FIG. 13 are views respectively showing one example of programs that the CPU core 104 executes. The program shown in FIG. 12 is common to the program shown in FIG. 5 on the point where the function B is called in the processing of the function A, however, it is different from the point where the command to call the function B is in a nesting of the branch instruction. Further, the program shown in FIG. 13 is common to the program shown in FIG. 5 on the point where the function B is called in the processing of the function A, however, it is different from the point where a function D (Function_d) stored in the high-speed memory is placed at a previous stage of the command to call the function B.

It is considered that the controller 10 shown in FIG. 4 executes the program shown in FIG. 12. At first, the CPU 100 executes the function A (S71). And then, the CPU 100 determines whether a value is 0 (S72). In the determination, when the result is true, the function A is ended (S73), otherwise, when the result is false (S74), the function B is called in the subsequent processing (S75). After the function B is executed (S77/S78), the processing of the function A is ended (S76).

In the series of processing, if the determination result of an if-statement is true, the processing of the function A is ended without the function B being called. Accordingly, if the step to call the command (the function C) to copy the program of the function B from the buffer unit 140 into the cache memory is inserted in the previous stage before Step S74, the function B is not called, therefore the copy processing into the cache memory 132 results in waste.

In such a case, the rule such that the backtrace is executed until the time when the function B is securely called is defined in the code insertion position definition table 92. In this example, at a step of an else-statement of Step 74, the function B is securely called when executing the statement, therefore, the copy processing into the cache memory 132 does not result in waste.

However, even in the case when the branch instruction is in the program, there exists the case where the function B is securely called. For example, in the if-statement among the codes of the function A in FIG. 12, in the case when the statement of return (1) is the instruction except return, it is determined that the function B is called at a stage to process a source code before the if-statement. In this case, even though the if-statement may exist, it does not influence the backtrace. The case to call the copy processing in the else-statement and the case to call the copy processing in the if-statement are considered, and adopting the one whose backtrace amount is large or adopting the one whose backtrace amount is small leads to a tradeoff, however, adopting the one whose backtrace amount is small makes it possible to eliminate waste of the backtrace.

On the other hand, in the case when there are the branch instruction and the jump instruction, it is possible to insert the code to call the copy processing in the position of a predetermined backtrace amount regarding these. In this case, no matter where the processing of the CPU 100 branches to, the copy processing from the buffer unit 140 into the cache memory can be executed securely.

It goes without saying that it is possible to insert the code to call the copy processing in the previous stage before starting to execute the function A at Step 71 in backtrace processing of the program shown in FIG. 12.

Subsequently, it is considered that the controller 10 shown in FIG. 4 executes the program shown in FIG. 13. At first, the CPU 100 executes the function A (S81). And then, the CPU 100 calls the function D (S82), and executes the processing of the function D (S86/S87). After the processing of the function D is ended, the CPU 100 calls the function B (S83), and executes the processing of the function B (S84/S85). After the processing of the function B is ended, the CPU 100 executes the subsequent processing of the function A, and the processing of the function A is ended.

In the series of processing, the function D stored in the high-speed memory is placed at the previous stage of the function B stored in the low-speed memory. In the case when the backtrace is executed in this program, there is a possibility that the position to be an adequate backtrace amount results in the previous stage of the function B at Step 83 and the subsequent stage of the function D at Step 82. In this case, since the function D is a format to be called as the subroutine, there arises a problem where the command to perform the copy processing is inserted.

As the rules to solve the problem, these methods are possible to consider, (1) not set the function D in the format to be called as the subroutine, but perform an inline expansion for the function D and incorporate the function D into the function A, (2) make a copy of the function D that is not called from another function, and then replace the function D at Step 82 with the copy, and so on. In the case when the function D is called from many other functions, the method of (1) has a problem that the expansion processing increases the amount of the program code enormously, however, the problem can be solved by providing rules to count the number of times that the function D is called, and perform the expansion processing in the case when the number of times that the function D is called is less than a predetermined number, and the like. The method of (2) does not require the expansion processing, however, leads to increase the amount of the code in case of the size of the function D being large. In this case, to provide the following rule such that “the present method is applied as long as the size of the function D is equal to or less than a predetermined value” leads to solve the problem.

As explained above, according to the HDD and the controller of this embodiment, it is configured such that the position where the function in the low-speed memory is called is grasped from the program code in the high-speed memory, and the program code of the function in the low-speed memory is cached beforehand, which makes the program code in the low-speed memory accessible at a high-speed without a cache miss. That is, processing efficiency can be improved. Further, according to the compiler and a program converter, a program source capable of a high-speed access can be generated.

It should be noted that the present invention is not limited exactly to the above-described embodiment, but when being implemented, the invention can be embodied by modifying the constituent elements within a range not departing from the spirit of the invention. For example, in the explanation of the above-described embodiment, the example of which the functions are placed respectively in the high-speed memory and the low-speed memory is explained, which is not limited to this. As long as the speed of the cache memory is sufficiently higher than the high-speed memory and the low-speed memory respectively, even in the case when the function A and the function B are placed in the same high-speed memory, speed-up of reading and executing the function B can be realized. Further, various inventions can be formed by appropriately combining the plural constituent elements disclosed in the above-described embodiment. For example, some constituent elements out of all the constituent elements shown in the embodiment may be deleted. Moreover, constituent elements in different embodiments may be appropriately combined.

What is claimed is:

1. An arithmetic device, comprising:
a memory configured to store a first program and a second program called from processing of the first program and executed;
a first arithmetic module configured to read the first program from the memory and to execute the first program;
a cache memory configured to store data temporarily with an access speed faster than an access speed of the memory;
a second arithmetic module configured to read the second program from the memory and to store the second program in the cache memory; and
a third arithmetic module configured to read the second program from the cache memory and to execute the second program in accordance with a call from first arithmetic module configured to execute the first program.

2. The arithmetic device of claim 1,
wherein the second program is embedded in processing of the first program and called from the first arithmetic module and executed, and
the memory comprises:
a first memory configured to store a first program; and
a second memory configured to store the second program, an access speed of the second memory being slower than an access speed of the first memory.

3. The arithmetic device of claim 2,
wherein an access speed of the cache memory is faster than the access speed of the second memory.

4. The arithmetic device of claim 1,
wherein the third arithmetic module is configured to first read the second program from the cache memory, and to read the second program from the second memory in case of failing in reading from the cache memory.

5. An arithmetic method, comprising:
storing a first program and a second program embedded in processing of the first program and called based on an execution of the first program in a memory;
reading the first program from the memory and executing the first program;
reading the second program from the memory and storing the read second program in a cache memory, an access speed of the cache memory being faster than an access speed of the memory, before the second program is called from the memory based on the execution of the first program; and
reading the second program from the cache memory and executing the second program, in accordance with a call of the second program based on the execution of the first program.

6. The arithmetic method of claim 5,
wherein the storing of the first program and the second program in the memory comprises:
storing the first program in a first memory; and
storing the second program in a second memory having an access speed slower than an access speed of the first memory; and
the storing of the second program in the cache memory includes reading the second program from the second memory and storing the read second program in the cache memory.

7. A hard disc controller, comprising:
the arithmetic device of claim 1; and
a motor driver configured to control an actuator where a spindle motor configured to rotate a disc and an element configured to perform recording and reproducing on the disc are disposed based on an execution result of the first and the second programs in the arithmetic device.

8. A hard disc device, comprising:
the hard disc controller of claim 7; and
an interface configured to connect to a host computer and configured to instruct recording or reproducing to the disc.

9. A program converter, comprising:
an analyzer configured to analyze a program source comprising a first instruction code stored in a first memory and a second instruction code stored in a second memory with an access speed slower than an access speed of the first memory, and called from the first instruction and executed in order to extract position information of the first instruction and the second instruction;
a definition table configured to define a reference in order to set a position for inserting a third instruction code copying the second instruction code from the second memory into a third memory storing data temporarily with an access speed faster than the access speed of the second memory regarding the program source;
a search module configured to search a position for inserting the third instruction code in the program source based on the reference defined by the definition table and the position information of the first and the second instructions; and
a code insertion module configured to insert the third instruction code in the position searched in the search module.

10. A complier, comprising:
the program converter of claim 9; and
a conversion module configured to convert a program source converted in the program converter into an executable format.
